(19) United States
(12) Patent Application Publication
(10) Pub. No.: US 2008/0095342 A1
(43) Pub. Date: Apr. 24, 2008

(54) Interception Of Cashless Calling Service Subscription

(76) Inventors: Amedeo Imbimbo, Caivano (IT); Enrico De Luca, Caserta (IT)

Correspondence Address: ERICSSON INC., 6300 LEGACY DRIVE, M/S EVR 1-C-11, PLANO, TX, 75024, US

(21) Appl. No.: 11/722,403

(22) PCT Filed: Dec. 29, 2004
(86) PCT No.: PCT/SE04/02046

§ 371 Date: Jun. 21, 2007

(51) Int. Cl. H04M 15/00

(52) U.S. Cl. 379/112.01

(57) ABSTRACT

The present invention relates to problems how to generate information related to use of a Cashless Calling Service Subscription. The problems are solved by methods and arrangements in a communication system to generate information related to use of the monitored Cashless Calling Service Subscription. The system provides the information to an Intercept Configuration Unit. The information is collected from the Interception Access Point that is associated to the monitored Cashless Calling Service Subscription. The method comprises the following step: receiving to the Interception Access Point a request to monitor the Cashless Calling Service Subscription number, detection of use of the monitored Cashless Calling Service Subscription number at the Interception Access Point, delivering information related to said use, from the Interception Access Point to the Intercept Configuration Unit.

### TECHNICAL FIELD OF THE INVENTION

The present invention relates to methods and arrangements in a communication system to provide information related to use of a Cashless Calling Service Subscription.

### DESCRIPTION OF RELATED ART

The trend of Intelligent Networks gives opportunity to new Communication Services that are centralized in the network. These services are normally hosted by a central node, a Service Control Point, and accessed via a phone or a computer. DTMF tones could be used to interact with the services. It is also possible to access the service indirect via service providers' personnel.

One of those services is Cashless Calling Service. A Cashless Calling Service makes it easy and cost efficient for essentially any potential user in any usage situation to make voice calls and to connect to Internet Networks without cash.

Examples of different types of access to Cashless Calling Services are:
Calling Line Identity: Validation of the user is based on the number from which the call is made.
Remote access: Access can be made from an undefined number. A pin-code/password is used to identify the user.
Access via service providers' personnel.
Remote internet access: A pin-code/password is used to identify the user.

Examples of different types of Cashless Calling Service Subscription are:
Prepaid Account is based on subscriptions. Examples of accesses are Calling Line Identity or Remote Access.
Prepaid Card Calling is based on calling cards. Calling cards represent a certain amount of prepaid calling time and come with an access number and personal codes.
Account Card Calling is a post-paid service.

In all these subscriptions there could also be possible to access via Internet Networks or via the personnel of the service provider. Other services than setting up a phone call or an internet connection are inquiry of the balance of your subscription account and refill of your subscription account.

There is a demand to monitor these new centralized communication services with indirect access at the same level of security and confidentiality as known from traditional communication services.

One way to monitor Communication Services is Lawful Interception, i.e. the act of intercepting a communication on behalf of a Law Enforcement Agency. Interception of traditional communications Content of Communication i.e. speech and data is known. Interception of Intercept Related Information is also known. Intercept Related Information is defined as signalling information related to target subscribers, for example call establishment. As an example, in Circuit Switching domain, the sending of Intercept Related Information to a monitoring function is triggered by the following call-related and non-call related events:
Call Establishment
Answer
Supplementary Service
Handover
Release
Subscriber Controlled Input

Appropriate session related and session unrelated events trigger the sending of Intercept Related Information to a monitoring function in case of Packet Switching communication.

According to current Lawful Interception standards, e.g. 3GPP TS 33.108 V6.6.0 (2004-06), it is not possible to report, by means of existing Intercept Related Information events, the occurrence of traffic and information related to use of a subscription with indirect access, like a Cashless Calling Service Subscription. The calling number used for the access of the subscription is not known, or it might not be lawful to intercept it even if it were known. In the case of Cashless Calling Service Subscription the destination number, to which the call shall be forwarded, is not known either.

### SUMMARY OF THE INVENTION

The present invention relates to problems how to generate information related to use of a Cashless Calling Service Subscription.

The problems are solved by associate an Interception Access Point IAP to the Cashless Calling Service Subscription and generate new properly structured information.

In more detail the problems are solved by methods and arrangements in a communication system to generate information related to use of the monitored Cashless Calling Service Subscription CCSS. The system provides the information to an Intercept Configuration Unit ICU. The information is collected from the IAP, which is associated to the monitored CCSS. The method comprises the following step:
receiving to the IAP a request to monitor the CCSS,
detection of use of the monitored CCSS at the IAP,
delivering information related to said use, from the IAP to the ICU

Advantages of the invention are that use of a CCSS can be monitored.

The invention will now be described more in detail with the aid of preferred embodiments in connection with the enclosed drawings.

### BRIEF DESCRIPTION OF THE DRAWINGS

FIG. 1 discloses a block schematic illustration of a communication system comprises a Cashless Calling Service Subscription CCSS and an Intercept Configuration Unit ICU.

FIG. 2 discloses a block schematic illustration of an ICU in the communication system.

FIG. 3 discloses a flow chart illustrating some essential method steps of the invention.

### DETAILED DESCRIPTION OF EMBODIMENTS

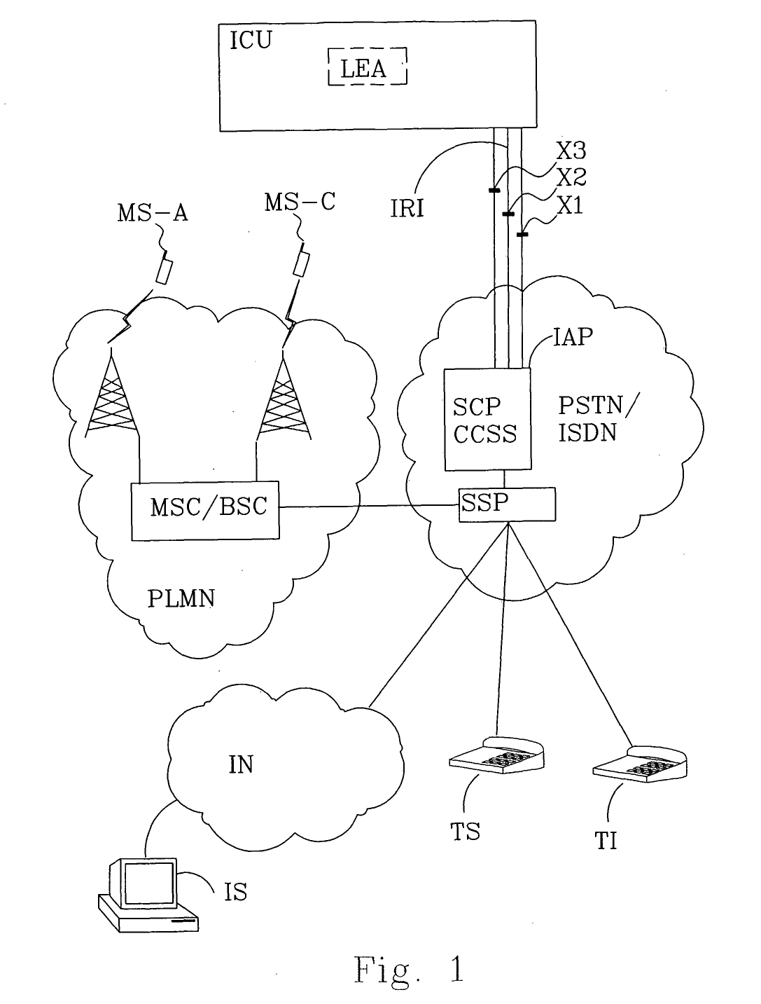

FIG. 1 discloses a communication network. The network in this example comprises a Public Switch Telephone Network PSTN, an Integrated Services and Digital Network ISDN, a Public Land Mobile Network PLMN, Internet Networks IN and user equipment (handsets and computers). The communication network also comprises a node, the Service Control Point SCP, which is hosting a Cashless Calling Service Subscription CCSS. The system also comprises an Intercept Configuration Unit ICU.

In this example the SCP is hosted by the PSTN. The SCP hosts the CCSS. The CCSS is accessed via a communication service, e.g. a fixed line subscription associated to one of the handsets, a mobile phone or a computer. The SCP is configured as an Interception Access Point IAP, which is associated to the CCSS. The IAP has intercept capabilities and can provide information, e.g. Intercept Related Information IRI, to an Intercept Configuration Unit ICU. A Telephony Subscriber TS is connected to the PSTN.

A subscriber TI is connected to the ISDN.

The PLMN in this example is a GSM network and comprises a Mobile Subscriber Centre MSC. The MSC is connected to a Base Station Controller BSC that is connected to an antenna via a Radio Base Station. Two Mobile Subscribers/Equipments MS-A and MS-C are connected to the PLMN.

An Internet Subscriber IS is connected to Internet Networks IN.

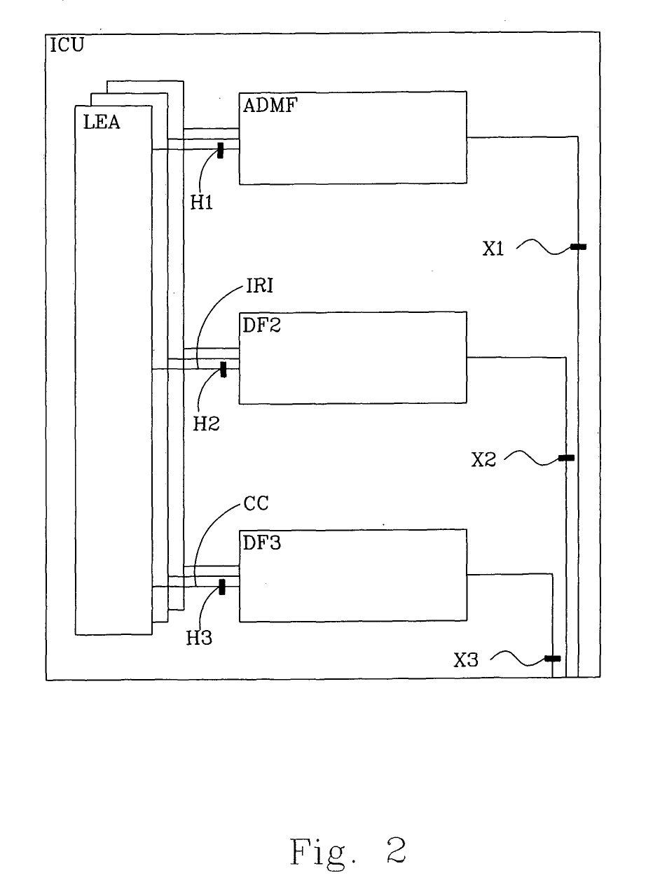

The ICU is connected to the node SCP hosting the CCSS. The ICU is connected to the node via three interfaces X1, X2 and X3. The ICU and the interfaces will be further explained in FIG. 2.

The Intercept Configuration Unit ICU is disclosed in FIG. 2. The ICU comprises at least one Law Enforcement Agency LEA (three blocks representing different LEAs are shown in FIG. 2). Each LEA is connected, via interfaces H1-H3, to three Mediation Functions respectively for ADMF, DF2 and DF3, i.e. an Administration Function ADMF and two Delivery Functions, a so-called second Delivery Function DF2 and third Delivery Function DF3. LEA is connected to the ADMF via interface H1, to the DF2 via interface H2 and to the DF3 via interface H3. The Administration Function and the Delivery Functions are each one connected to the communication network via the interfaces X1-X3. The ADMF is connected via the interface X1, DF2 is connected via X2 and DF3 is connected via X3. The Administration Function ADMF is together with the delivery functions used to hide from the network that there might be multiple activations by the different Law Enforcement Agencies. The messages sent from the ADMF to the network via the X1 interface comprise identities of the subscriber/equipment that is to be monitored, i.e. target identities. The second Delivery Function DF2 receives Intercept Related Information IRI from the network and DF2 is used to distribute the IRI to relevant Law Enforcement Agencies. The third Delivery Function DF3 receives Content of Communication CC, i.e. speech and data, and is used to distribute the CC to relevant LEAs. DF3 is responsible for call control signalling and bearer transport for an intercepted product.

Sending of Intercept Related Information IRI to a monitoring function is triggered by Events, these are either call related or non-call related. Call establishment is an example of a call related Event and Location update is an example of a non-call related Event. Access to a CCSS is an Event that could trigger the sending of IRI to the ICU.

Intercept Related Information IRI, received by DF2, is defined as signalling information related to monitored subscriptions. Examples of parameters in the IRI report when a Cashless Calling Service (CCS) is used are as follows:
SCP Event Type: Information on events in the SCP node. E.g. CCS Access.
Observed CCS Subscription Number,
Event Time: The time of the event generation in the service-providing node.
Event Date: The date of the event generation in the service-providing node.
Network Element Identifier: Unique identifier for the element (Interception Access Point) reporting the Interception.
Observed MSISDN: The MSISDN of the target subscriber,
CCS Accessed Service: Information on which type of services that is accessed, e.g. prepaid account, prepaid card calling, account card calling, prepaid account internet access, prepaid Card calling internet access, account card calling internet access.
CCS Access Number: It could be separated numbers for different CCS subscriptions and for different service providers.
CCS Calling Number: E.g. number of the mobile phone, fixed telephone or computer the user use to access the CCS.
CCS Destination Number: E.g. the mobile phone number or fixed telephone number to which the call shall be forwarded.
CCS Access Failure Reason: Used if access fails.

It is to be observed that the above stated parameters only are examples of parameters in the IRI report related to use of a CCSS. These parameters could be forwarded from the IAP to the ICU.

A method according to an embodiment of the invention will now be explained more in detail. The explanation is to be read together with FIGS. 1 and 2. The Cashless Calling Service Subscription CCSS to be monitored is hosted by a node, in this example the Service Control Point SCP. This is a node that also could host other centralized services in the network.

The type of CCSS is in this embodiment is a Prepaid Account Subscription. This subscription could be accessed from any phone or computer, so called remote access. A pin code or similar could be used to identify the user. In this case the user has a Calling Line Identity access and identification is made by the number he is calling from, the A-number. This A-number is predefined as a Calling Line Identity number in the Prepaid Account Subscription CCSS.

The user will access the CCSS via a Mobile Subscription/Equipment MS-A. The user dials the Cash Calling Service Access Number, the B-number. He provides the number of his CCSS, the CCSS-number, by sending the number via DTMF tones. He will also provide the destination number, the C-number, of the called party MS-C via DTMF tones.

The CCSS will be associated to an Interception Access Point IAP, in this case the SCP. The SCP is configured as an IAP. The method to intercept the CCSS when the user MS-A calls another party MS-C comprises the following steps:
The Law Enforcement Agency LEA sends via interface H1 a request to the Administration Function ADMF to activate interception of the Cashless Calling Service Subscription number CCSS. This means that the CCSS number will be monitored, i.e. it will be the target of the interception.
The ADMF forwards via interface X1 a target identity of the CCSS to the Interception Access Point IAP/SCP.
The user MS-A dials the Prepaid Account Subscription Access number, i.e. the B-number, from his mobile phone, the A-number. This communication will be set up in a traditional way in the PLMN and the PSTN.
The Service Control Point SCP asks the user to provide the Prepaid Account Subscription number, i.e. the CCSS-number, and the destination number, the C-number, via DTMF.
The provided CCSS number is identified by the IAP/SCP as an intercepted target.
The Observed CCSS Number, SCP event type (=CCS access), Event Time, Event date, Network Element Identifier, CCS accessed service (=Prepaid Account Subscription), CCS Access Number (=Prepaid Account Subscription Access Number, B-number), Calling Number (A-number) and Destination Number (C-number) are sent as Intercept Related Information IRI from the IAP to the Delivery Function DF2 via interface X2.
The IRI is forwarded from DF2 to the LEA via interface H2.
The SCP will set up a connection between the calling party MS-A and the called party MS-C. The content of the call will be transferred between MS-A and MS-C in the PLMN and PSTN networks and will not pass via the SCP node.

If the LEA wants to intercept the content of the call, it could initiate an interception of content of the call and/or the IRI of the Calling Number, A-number, or the Destination Number, C-number. There is also a possibility to let the IAP or any other element in the communication system initiate an interception of any of those numbers. This requires that the nodes handling the call content of the subscriptions to be intercepted are configured as Interception Access Points.

The steps above could come in another order. It is e.g. flexible at what step the IAP will send IRI to the DF2. Other steps are also possible. If the user does not have a Calling Line Identity access there might be a step of identification of the user. The SCP will ask for a pin code that will be sent to the SCP via e.g. DTMF.

The IRI parameters mentioned above are only examples of IRI and other types are possible. If the access to the CCSS fails, an Access Failure Reason could be forwarded from the IAP via the DF2 to the LEA. If an access code is used, that code could also be sent as IRI. It is also not necessary to include all events mentioned in the method above, just one IRI parameter could be enough.

The CCSS does not have to be a Prepaid Account Subscription as in this example. Examples of other possibilities are:
Prepaid Card Calling based on calling cards. Calling cards represent a certain amount of prepaid calling time and come with an access number and personal codes.
Account Card Calling that is a post-paid service.

In this example the user has a Calling Line Identity access and identification is made by the number he is calling from, the A-number. This A-number is predefined as a Calling Line Identity number in the Prepaid Account Subscription. One of these predefined numbers could also be used as target identity instead of the CCSS number. It will then be the predefined A-number that will be identified by the IAP/SCP as an intercepted target and that will trigger the sending of Intercept Related Information IRI from the IAP/SCP to the DF2 via X2. In case of fixed phone or mobile phone the A-number could be in form of E.164. For a mobile phone the MSISDN number could be used.

The access to the CCSS does not have to be via Calling Line identity. Examples of other types of accesses are:
Remote Access where the access can be made from any number or subscription/equipment. A pin-code/password is normally used to identify the user. A remote internet access is also possible.
Access via service providers' personnel.

The SCP node could be hosted by any communication network, e.g. ISDN, PSTN, PLMN or Internet Networks. The CCSS could also be hosted by another node than the SCP, in that case that node will be the IAP instead of the SCP.

The calling party MS-A and the called party MS-C do not have to use mobile subscription as in the example. Any of them could use any type of subscriptions, e.g. a traditional PSTN subscription TS, an ISDN subscription TI or an Internet Subscription IS. If one of them use a mobile subscription it does not have to be a GSM net, any mobile network will do. If both of them use a GSM subscription they do not have to be connected to the same MSC/BSC as in the example.

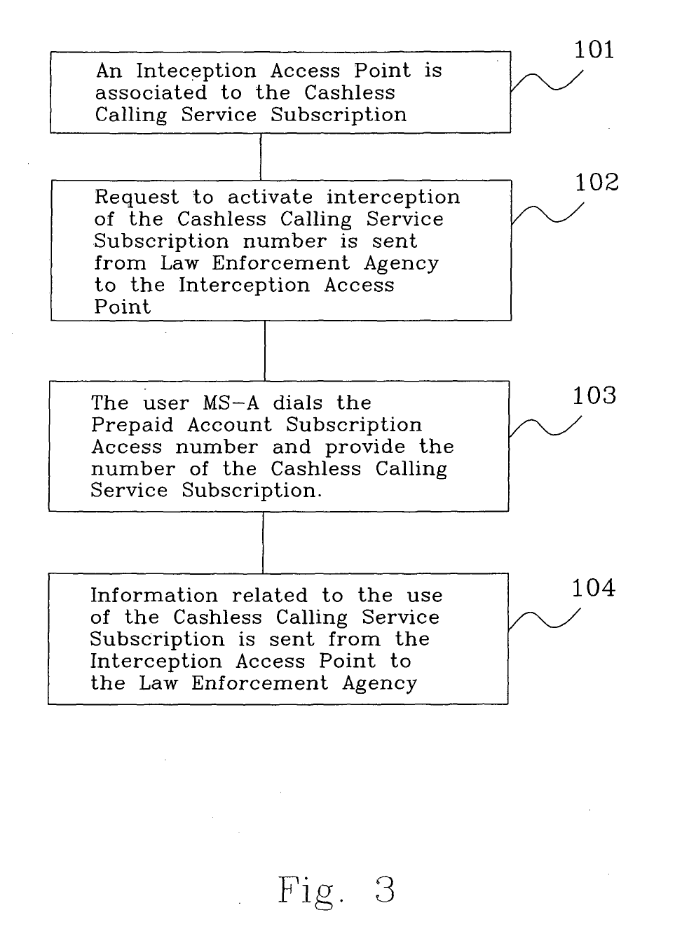

FIG. 3 discloses a flowchart in which some more important steps are shown. The flowchart is to be read together with the earlier shown figures. The flowchart comprises the following steps:
The Cashless Calling Service Subscription is associated to an Interception Access Point. A block 101 discloses this step in FIG. 3.
The Law Enforcement Agency LEA sends a request to the Interception Access Point IAP, to activate interception of the Cashless Calling Service Subscription number. A block 102 discloses this step in FIG. 3.
The user MS-A dials the Prepaid Account Subscription Access number and provide the Prepaid Account Subscription number, i.e. the number of the Cashless Calling Service Subscription. A block 103 discloses this step in FIG. 3.
The IAP sends Intercept Related Information IRI related to the use of the Cashless Calling Service Subscription, to the LEA. A block 104 discloses this step in FIG. 3.

The invention is of course not limited to the above described and in the drawings shown embodiments but can be modified within the scope of the enclosed claims.

1. A method in a communication system to generate information related to use of a Cashless Calling Service Subscription which is accessed via a Communication Service, which system comprises the Cashless Calling Service Subscription and the Communication Service and which system is configured to provide to an Intercept Configuration Unit information collected from an Interception Access Point characterized in that the Interception Access Point is associated to the Cashless Calling Service Subscription, which method comprises the following steps,
receiving to the Interception Access Point a request to monitor the Cashless Calling Service Subscription,
detection of use of the Cashless Calling Service Subscription at the Interception Access Point,
delivering information related to said use, from the Interception Access Point to the Intercept Configuration Unit.

2. The method in a communication system according to claim 1 whereby the Intercept Configuration Unit comprises a Law Enforcement Agency attached to an Administration Function, which method comprises the following further steps:
sending from the Law Enforcement Agency to the Administration Function, the request to monitor the Cashless Calling Service Subscription;
forwarding the request from the Administration Function to the Interception Access Point

3. The method in a communication system according to claim 1 comprises the following further step:
the Communication System initiates an interception of the Communication Service used to access the Cashless Calling Service Subscription.

4. The method in a communication system according to claim 1 comprises the following further step:
the Communication System initiates an interception of the destination number of the call set up by the Cashless Calling Service.

5. The method according to claim 1 whereby the information delivered from the Interception Access Point to the Intercept Configuration Unit comprises at least one of the following data:
Observed Cashless Calling Service Subscription Number,
Event Time,
Event Date,
Cashless Calling Service Accessed Service,
Cashless Calling Service Calling Number,
Cashless Calling Service Destination Number.

6. The method in a communication system according to claim 1 where the Cashless Calling Service Subscription is any of the following types:
Prepaid Account based on subscriptions,
Prepaid Card Calling based on calling cards,
Account Card Calling based on post-paid service.

7. The method in a communication system according to claim 1 where the access to the Cashless Calling Service is any of the following types:
Calling Line Identity,
Remote Access,
Access via a service providers personnel.

8. An arrangement in a communication system to generate information related to use of a Cashless Calling Service Subscription which is accessed via a Communication Service, which system comprises the Cashless Calling Service Subscription and the Communication Service and which system is configured to provide to an Intercept Configuration Unit information collected from an Interception Access Point characterized in that the Interception Access Point is associated to the Cashless Calling Service Subscription, which arrangement comprises,
means for receiving to the Interception Access Point a request to monitor the Cashless Calling Service Subscription,
means for detection of use of the Cashless Calling Service Subscription at the Interception Access Point,
means for delivering information related to said use, from the Interception Access Point to the Intercept Configuration Unit.

9. The arrangement in a communication system according to claim 8 whereby the Intercept Configuration Unit comprises a Law Enforcement Agency attached to an Administration Function, which arrangement comprises:
means for sending from the Law Enforcement Agency to the Administration Function, the request to monitor the Cashless Calling Service Subscription;
means for forwarding the request from the Administration Function to the Interception Access Point.

10. The arrangement in a communication system according to claim 8 comprises:
means for initiating an interception of the Communication Service used to access the Cashless Calling Service Subscription.

11. The arrangement in a communication system according to claim 8 comprises:
means for initiating an interception of the destination number of the call set up by the Cashless Calling Service.

12. The arrangement according to claim 8 whereby the information delivered from the Interception Access Point to the Intercept Configuration Unit comprises at least on of the following data:
Observed Cashless Calling Service Subscription Number,
Event Time,
Event Date,
Cashless Calling Service Accessed Service,
Cashless Calling Service Calling Number,
Cashless Calling Service Destination Number.

13. The arrangement according to claim 8 where the Cashless Calling Service Subscription is any of the following types:
Prepaid Account based on subscriptions,
Prepaid Card Calling based on calling cards,
Account Card Calling based on post-paid service.

14. The arrangement according to claim 8 where the access to the Cashless Calling Service is any of the following types:
Calling Line Identity,
Remote Access,
Access via a service providers personnel.
